(19) United States
(12) Patent Application Publication
(10) Pub. No.: US 2026/0105293 A1
(43) Pub. Date: Apr. 16, 2026

(54) METHOD AND APPARATUS FOR SELF-ADAPTIVE DIGITAL-ANALOG HYBRID LEARNING FOR ANALOG IN-MEMORY COMPUTING, AND RECORDING MEDIUM THEREOF

(71) Applicant: SEOUL NATIONAL UNIVERSITY R&DB FOUNDATION, Seoul (KR)

(72) Inventors: Sangbum KIM, Seoul (KR); Young Woon CHO, Goyang-si (KR); Sungmin LEE, Yongin-si (KR)

(73) Assignee: SEOUL NATIONAL UNIVERSITY R&DB FOUNDATION, Seoul (KR)

(21) Appl. No.: 19/358,999

(22) Filed: Oct. 15, 2025

(30) Foreign Application Priority Data
Oct. 16, 2024 (KR) 10-2024-0141344
Mar. 31, 2025 (KR) 10-2025-0041308

(51) Int. Cl. G06N 3/065; G06N 3/048; G06N 3/096

(52) U.S. Cl. CPC G06N 3/065; G06N 3/048; G06N 3/096

(57) ABSTRACT

The present disclosure relates to a self-adaptive learning method and apparatus for efficiently training deep neural networks in neuromorphic hardware using a hybrid structure combining an analog backbone network with a digital attention block to overcome performance degradation due to the non-ideal characteristics of an analog memory device, and a recording medium for implementing the same.

### CROSS REFERENCE TO RELATED APPLICATION

The present application claims priority to Korean Patent Application No. 10-2024-0141344, filed on Oct. 16, 2024, and No. 10-2025-0041308, filed on Mar. 31, 2025, the entire contents of which is incorporated herein for all purposes by this reference.

### BACKGROUND OF THE INVENTION

### Field of the Invention

The present disclosure relates to a method and apparatus for a self-adaptive learning for efficiently training deep neural networks in neuromorphic hardware using a hybrid structure combining an analog backbone network with a digital attention block to overcome performance degradation due to the non-ideal characteristics of an analog memory device, and a recording medium for implementing the same.

### Description of the Related Art

Analog in-memory computing (AIMC) is attracting attention as a promising technology for energy-efficient acceleration of deep learning workloads. Recently, deep neural networks (DNNs) have made remarkable progress in fields such as computer vision, speech recognition, robotics, and the like, but the training of increasingly large and complex neural networks requires significant computational time and energy costs, posing significant challenges to sustainability. The optimization of the performance and energy efficiency of artificial intelligence (AI) computing hardware is emerging as a key challenge, particularly for AI applications in low-power systems, such as Internet of Things (IoT) devices and edge computing platforms.

To solve such a problem, highly optimized digital application-specific integrated circuits (ASICs) have been developed to accelerate deep learning workloads. Various optimization strategies, such as quantization, binarization, and compression, have focused on reducing the size and number of required computations, but digital implementations still incur significant energy consumption and processing times for large networks.

As an alternative to conventional digital computing technologies, AIMC systems provides significant advantages in enabling low-power and parallel computation. Based on Ohm's law and Kirchhoff's current law, an AIMC framework facilitates massively parallel matrix-vector multiplications (MVM) by storing weight matrices using resistive memory arrays and applying voltages corresponding to input vector values. In addition, a pulse matching technique and gradual conductance adjustment enable parallel computation of rank-one outer products across the entire crossbar array, thereby achieving approximately O(1) time complexity. Consequently, the AIMC systems are expected to provide significantly faster performance and greater energy efficiency than digital alternatives and have successfully accelerated on-chip inference using pre-trained models.

However, practical implementation of on-chip training systems using AIMC faces several challenges due to the non-ideal characteristics of memory devices. One of the major challenges is the asymmetry in conductance updates, in which the amount of conductance increase and decrease at a given conductance level are not equal, thereby severely affecting system performance. In addition, the limited precision of analog devices, compared to the high-precision floating-point arithmetic used in a standard stochastic gradient descent (SGD) algorithm, significantly degrades performance as the number of bits decreases. Inherent device-to-device variability further complicates the implementation of many algorithmic ideas that assume translation invariance. Efforts are underway to develop memory devices with symmetric conductance updates, but achieving ideal symmetry still remains a challenge.

Some innovative solutions to address the non-ideal characteristics of an analog memory device include the development of specialized on-chip training algorithms. A Tiki-Taka algorithm effectively addresses asymmetry using two arrays, that is, an auxiliary array that records gradient history and a main array that stores weight values. Backpropagation gradients are temporarily updated in the auxiliary array, and the accumulated gradients are periodically updated in the main array. Simulations show that the Tiki-Taka algorithm can achieve performance comparable to ideal devices across various types and sizes of networks even when using asymmetric device models. However, the requirement to double the analog hardware can incur additional costs.

In addition, an alternative approach to addressing the limited conductance states and device-to-device variations of an analog memory device is a mixed-precision method. This approach uses analog devices for forward and backward computations and stores weight updates in a high-precision FP32 digital memory. This method allows updates to be transferred as a single-shot pulse when a specific threshold is exceeded, thereby maintaining accuracy while sacrificing some speed and efficiency. In this way, an on-chip training approach for compensating for the non-ideality of AIMC systems has been proposed, requiring innovations co-designed with algorithms, circuits, and particularly network systems.

In addition, complementary machine learning techniques such as knowledge distillation (KD) have been explored to solve hardware implementation problems. The KD can be used to mitigate device variability by transferring knowledge from a larger model (teacher) to a smaller model (student). Related research has developed a joint solution combining KD and online sparse adaptation (OSA) to effectively restore inference accuracy in the presence of RRAM variability while ensuring minimal area overhead. With the advancement in the KD, self-distillation (SD) has significantly improved the efficiency of deep neural networks by integrating an attention-based shallow classifier. The SD streamlines the training process into a single, cohesive stage in which teacher and student models can be trained together, thereby improving performance, particularly in resource-constrained environments such as on-device AI and the IoT.

However, conventional approaches still have limitations that fail to fully overcome the non-ideal characteristics of analog in-memory computing or requires additional hardware resources. Accordingly, there is a need for a new on-chip training methodology that can effectively overcome the non-ideal characteristics of analog devices and maintain hardware efficiency.

### SUMMARY OF THE INVENTION

The present disclosure is directed to providing a self-adaptive learning method and apparatus that improves the accuracy of on-chip learning through a hybrid structure that efficiently combines an analog backbone network with a digital attention block and optimizes energy efficiency by removing unnecessary digital components during an inference stage, in order to overcome the performance degradation problem due to non-ideal characteristics, such as asymmetric conductance update of memory devices, limited precision, device-to-device variation, and the like, in conventional analog in-memory computing systems.

According to an embodiment, there is provided a self-adaptive digital-analog hybrid learning method for analog in-memory computing (AIMC) based on a backbone network including an analog memory device and a self-adaptive network including a digital attention block, the method including performing on-chip learning using learning data while activating both the backbone network and the digital attention block, computing a loss function based on an output of the backbone network and an output of the digital attention block, and updating parameters of the backbone network using the loss function, wherein gradients from the digital attention block correct errors due to non-ideal hardware characteristics during the learning process of the backbone network.

The on-chip learning may perform a self-distillation process upon the activation of the digital attention block, thereby directly transferring knowledge from a ground truth to each digital attention block.

The on-chip learning may be performed by activating the digital attention block at predetermined intervals Ts according to a sparse strategy.

The on-chip learning may be performed by activating the digital attention block only during an initial learning period (Tw) according to a warm-up strategy and then deactivating the digital attention block.

The loss function may be computed as a weighted sum of the cross-entropy loss for the output of the backbone network and the cross-entropy loss for the output of each digital attention block, and the loss for the output of the digital attention block may be computed directly from the ground truth without a self-distillation process in the backbone network.

The non-ideal characteristics occurring during parameter learning of the backbone network may include at least one of conductance update asymmetry of the analog memory elements, the limited number of conductance states, or inter-device variation, and the digital attention block may guide the backbone network in a direction adapting to the non-ideal characteristics.

In an embodiment, an intermediate feature map obtained during the learning process of the backbone network may be input to the digital attention block, the digital attention block may perform classification based on the intermediate feature map, the gradients generated from the digital attention block may be transferred to the corresponding connection point of the backbone network to serve as a guide for the learning of the backbone network, and the gradient may guide the backbone network to adapt to the physical constraints of the analog memory device during the self-distillation process.

In an embodiment, the method may further include deactivating the digital attention block among the backbone network and the digital attention block and performing inference using only the backbone network.

According to the present disclosure, through the hybrid architecture that combines the analog backbone network with the attachable digital attention block, during learning, gradients from the digital attention block can assist in overcoming the non-ideal characteristics of the analog hardware, achieve up to a 13.1% improvement in CIFAR-10 image classification, and during inference, only the analog backbone network can be used to significantly reduce power consumption, and furthermore, by employing sparsity and warm-up strategies, the use of digital processing units (DPUs) can be minimized, thereby reducing the relative power up to about 70%.

### BRIEF DESCRIPTION OF THE DRAWINGS

FIG. 1 schematically illustrates an on-chip training structure of the present disclosure.

FIG. 2 schematically illustrates an on-chip inference structure of the present disclosure.

FIG. 3 illustrates a communication interface in on-chip training of the present disclosure.

FIG. 4 illustrates a communication interface in on-chip inference of the present disclosure.

FIG. 5 illustrates an example of a self-adaptation process of the present disclosure.

FIG. 6 is a flowchart of a self-adaptive digital-analog hybrid learning method for analog in-memory computing (AIMC) according to one embodiment.

FIG. 7 illustrates a configuration of a self-adaptive network according to one embodiment.

FIG. 8 is a block diagram of a computing device implementing the self-adaptive digital-analog hybrid learning method for AIMC according to one embodiment.

### DETAILED DESCRIPTION OF THE INVENTION

Hereinafter, embodiments of the present disclosure will be described in detail with reference to the drawings. However, the detailed descriptions of functions or components that can obscure the gist of the present disclosure in the following descriptions and the accompanying drawings will be omitted. In addition, throughout the specification, when a certain portion “includes” a certain component, it means that the certain portion may further include the other component rather than precluding the other component unless specifically stated to the contrary.

In addition, terms such as “first,” “second,” and the like may be used to describe various components, but the components should not be limited by the terms. The terms may be used to distinguish one component from another component. For example, a first component may be referred to as a second component, and similarly, the second component may also be referred to as the first component without departing from the scope of the present disclosure.

The terms used in the present disclosure are only used to describe specific embodiments and are not intended to limit the present disclosure. The singular includes the plural unless the context clearly dictates otherwise. In the present application, it should be understood that the term “include” or “have” is intended to specify that a feature, a number, a step, an operation, a component, a part, or a combination thereof is present, but does not preclude the possibility of the presence or addition of one or more other features, numbers, steps, operations, components, parts, or combinations thereof in advance.

Unless otherwise defined, all terms including technical and scientific terms used herein have the same meanings as those commonly understood by those skilled in the art to which the present disclosure pertains. The terms defined in a generally used dictionary should be construed as having meanings that coincide with the meanings of the terms from the context of the related technology and are not construed as an ideal or excessively formal meaning unless clearly defined in the present disclosure.

The present disclosure is to solve problems caused when large-scale neural networks are implemented in analog in-memory computing (AIMC) systems. AIMC provides significant energy efficiency and parallel computing advantages for deep learning tasks, but non-ideal hardware characteristics, such as conductance update asymmetry, limited precision, and device-to-device variability, have hindered effective on-chip learning.

The present disclosure is innovative in that it features a self-adaptive network (SAnet) architecture that integrates an analog backbone network with a detachable digital attention block inspired by self-distillation techniques. During on-chip learning, analog and digital components operate together, and the digital attention block provides a more accurate convergence direction that mitigates the non-ideal effects of a resistive processing unit (RPU). However, during an inference stage, only the analog backbone may be used, thereby significantly reducing power consumption.

Instead of requiring perfect hardware, the present disclosure enables neural networks to adapt to hardware non-idealities, thereby effectively addressing the scalability issues of neuromorphic computing systems. Such an approach differs from conventional methods, such as a Tiki-Taka algorithm or mixed precision, and provides a more flexible and energy-efficient solution for deploying deep neural networks in edge computing and Internet of Things (IoT) applications.

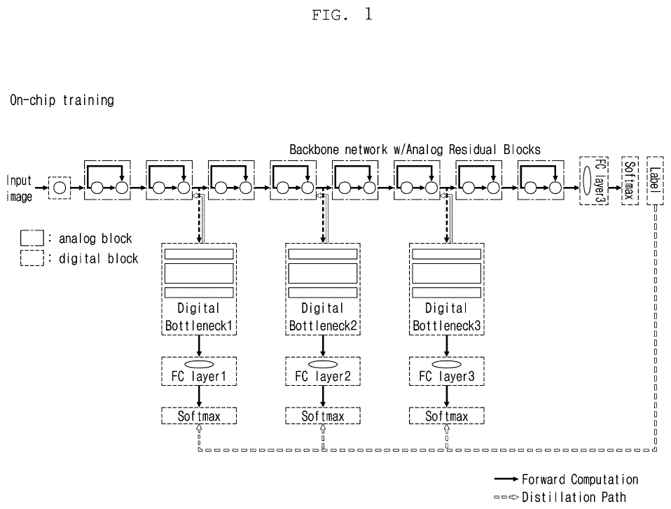

The present disclosure proposes a training method of overcoming the non-ideal characteristics of memory devices in the AIMC systems. As illustrated in FIGS. 1 to 5, the present disclosure uses an SAnet that combines an analog backbone network with a digital attention block as a core structure. FIG. 1 schematically illustrates a configuration of a system of the present disclosure.

Regarding an on-chip training structure illustrated in FIG. 1, the present disclosure includes a backbone network composed of analog residual blocks and a plurality of digital attention blocks. During a training process, an input image is processed through a forward computation path, and intermediate features are processed in the digital attention block through a distillation path. Such a dual-path approach enables a network to effectively adapt to the non-ideal characteristics of analog devices.

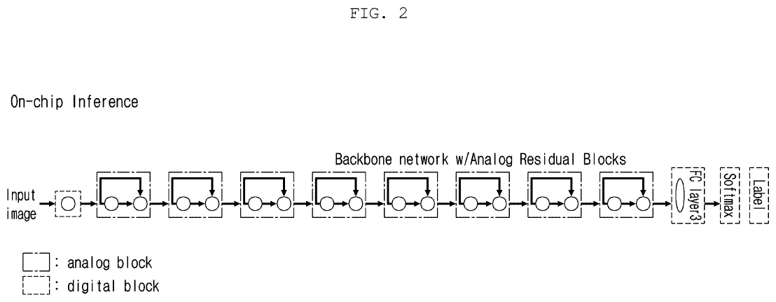

On the other hand, an on-chip inference architecture illustrated in FIG. 2 uses only an analog backbone network without a digital attention block. This significantly increases energy efficiency by removing unnecessary digital components during an inference stage.

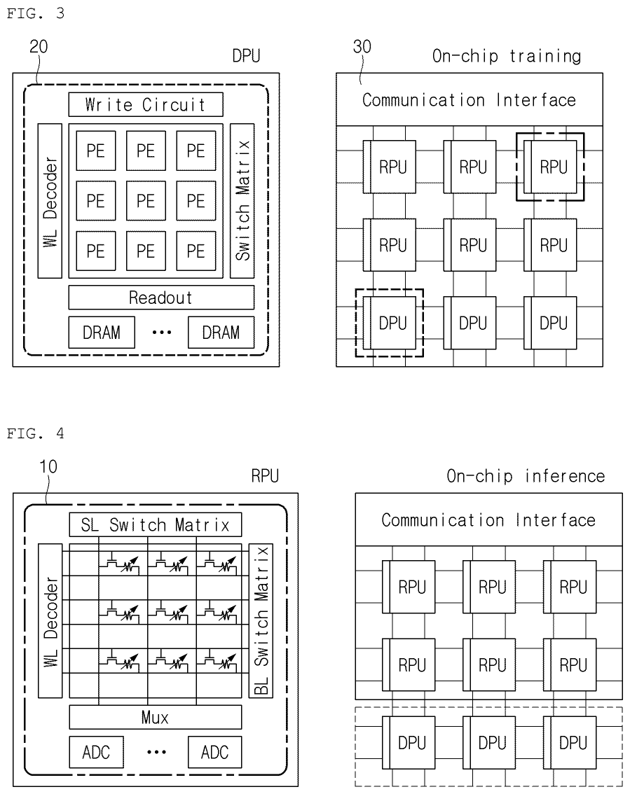

From a hardware perspective, the present disclosure uses both resistive processing units (RPUs) and digital processing units (DPUs) during on-chip training as illustrated in FIG. 3. The RPU is composed of memory-based unit cells in a crossbar array form and includes nearby components (a bit line driver, an analog-to-digital converter (ADC)/a digital-to-analog converter (DAC), a digital post-processing unit, a controller, a communication interface). The DPU handles the computation of a digital attention block and provides a precise computing environment without hardware constraints. On the other hand, during on-chip inference illustrated in FIG. 4, only the RPU is activated, thereby minimizing power consumption.

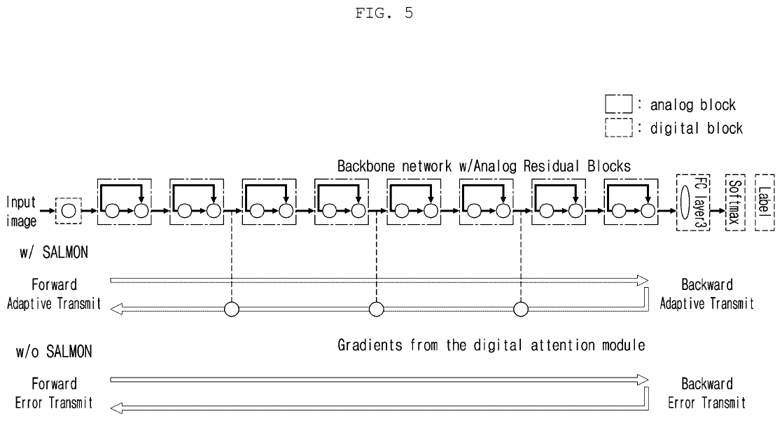

One of the major features of the present disclosure lies in a self-adaptation process illustrated in FIG. 5. Gradients of the digital attention block provides a more accurate convergence direction than gradients of the analog backbone network, thereby mitigating the effects of the non-ideal characteristics of the RPU. Such a self-adaptation mechanism enhances the performance of deep neural networks by inducing a model to adapt to hardware non-idealities.

The present disclosure presents a novel approach that overcomes the limitations of conventional AIMC systems and maintains energy efficiency. In particular, it is possible to achieve excellent performance even under various non-ideal characteristics of an analog memory device, such as conductance update asymmetry, limited precision, device-to-device variation, etc. This is demonstrated by up to 13.1% performance improvement and about 70% power consumption reduction on the CIFAR-10 image classification task.

Ultimately, the present disclosure provides an innovative hybrid approach that combines the energy efficiency of analog in-memory computing with the accuracy of digital computing and is expected to make a significant contribution to the advancement of next-generation, low-power AI hardware.

Hereinafter, an operation process of the AIMC based on a backbone network including an analog memory device and a self-adaptive network including a digital attention block according to the present disclosure will be described in more detail as follows.

In the present disclosure, the AIMC is implemented through the self-adaptive network illustrated in FIGS. 1 to 5. The specific operation of this system is as follows:

### 1. Network Architecture (see FIGS. 1 to 5)

The present disclosure includes two main components.

One is an analog backbone network and the other is a digital attention block.

First, the analog backbone network is composed of analog residual blocks and uses resistive memory devices. The digital attention block is a digital processing unit inspired by a self-distillation approach and is connected to various layers of the backbone network.

Meanwhile, traditional knowledge distillation transfers knowledge from a large teacher model to a small student model. The teacher model is trained first and then transfers its knowledge to the student model. This process requires two separate models.

In contrast, in the present disclosure, through the extension of such concept, self-distillation has the teacher and student coexist within the same network, attaches shallow classifiers at various depths of the network to allow each classifier to make its own predictions, and is configured such that a final output and outputs of intermediate classifier are trained simultaneously.

In the present disclosure, this self-distillation concept is used as follows.

### 1. Position of Digital Attention Block

Digital attention blocks are disposed at various depths within the backbone network. This is similar to the concept of arranging intermediate classifiers at various depths in the self-distillation.

### 2. Direction of Knowledge Transfer

Unlike typical self-distillation, the present disclosure “applies distillation loss only from a ground truth to an attention block.” This enhances the ability of the backbone network to adapt to neuromorphic hardware constraints.

### 3. Loss Calculation Method

The present disclosure can also apply cross-entropy loss to both the output of the backbone network and outputs of three digital attention blocks.

In conclusion, the digital attention block of the present disclosure borrows the conceptual architecture of the self-distillation (classifiers of various depths) and is modified according to the characteristics of AIMC. Accordingly, the non-ideal characteristics of analog hardware can be mitigated, and a more accurate gradient direction can be provided during the learning process.

### 2. Learning and Inference Processes (See FIGS. 1 and 2)

First, the on-chip learning process (see FIG. 1) is as follows.

When an input image is input to the system, data is propagated through the analog backbone network in a forward direction.

Intermediate feature maps are transferred to the digital attention blocks, and the backbone network and each digital attention block output classification results.

A loss function calculates a difference between these outputs and a true ground truth, and during backpropagation, gradients generated from the digital attention block guides the learning of the backbone network.

Next, the on-chip inference process (see FIG. 2) is as follows.

During the inference stage, the digital attention block is deactivated, and only the backbone network is activated, generating an output from the input image. This significantly increases energy efficiency.

### 3. Hardware Architecture (See FIGS. 3 and 4)

### Hardware for On-Chip Learning (See FIG. 3)

A resistive processing unit (RPU) 10 is a memory-based unit cell configured in a crossbar array and performs analog computations.

A digital processing unit (DPU) 20 is composed of processing elements for implementing the digital attention blocks.

A communication interface 30 supports data exchange between the RPU 10 and the DPU 20.

### Hardware for On-Chip Inference (See FIG. 4)

During inference, only the RPU 10 is activated, and the DPU 20 is deactivated, thereby reducing power consumption.

### 4. Self-Adaptation Mechanism (See FIG. 5)

The self-adaptation mechanism, which is a key feature of the present disclosure, operates as follows.

First, the flow of the conventional method (without SALMON) generates errors during forward and backward propagation due to the non-ideal characteristics of analog devices, and these errors are amplified during the learning process, thereby inevitably degrading overall performance.

In contrast, the gradients generated by the digital attention block of the present disclosure (with SAIMON) provide a more accurate convergence direction to the backbone network. This can mitigate the impact of the non-ideal characteristics of the analog devices (conductance update asymmetry, limited precision, and device-to-device variation), enabling the network to adapt to hardware non-ideality.

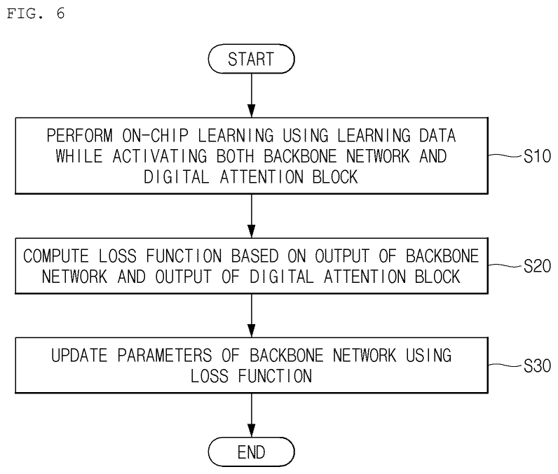

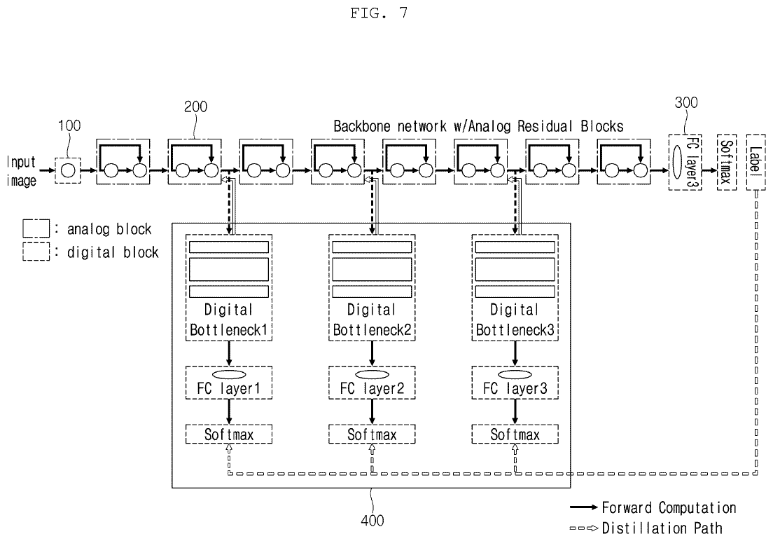

One embodiment of the present disclosure implemented based on the theoretical foundation provides a self-adaptive digital-analog hybrid learning method for AIMC based on a self-adaptive network including a backbone network including an analog memory device and digital attention blocks, as illustrated in FIG. 6, including performing on-chip learning using learning data while activating both the backbone network and the digital attention block (S10), calculating a loss function based on an output from the backbone network and an output from the digital attention block (S20), and updating parameters of the backbone network using the loss function (S30), in which gradients from the digital attention block correct errors due to non-ideal hardware characteristics during the learning process of the backbone network.

The on-chip learning is performed by activating the digital attention block at predetermined intervals Ts according to a sparse strategy.

The on-chip learning performs a self-distillation process during the activation of the digital attention block to directly transfer knowledge from a ground truth to each digital attention block.

The on-chip learning is performed by activating the digital attention block at the predetermined intervals Ts according to the sparse strategy or activating the digital attention block only during an initial learning period Tw according to a warm-up strategy, and then deactivating the digital attention block.

The loss function is computed as a weighted sum of the cross-entropy loss for the output of the backbone network and the cross-entropy loss for the output of each digital attention block, and the loss for the output of the digital attention block is computed directly from the ground truth without a self-distillation process in the backbone network.

The non-ideal characteristics occurring during parameter learning of the backbone network include at least one of conductance update asymmetry of the analog memory elements, the limited number of conductance states, or inter-device variation, and the digital attention block guides the backbone network in a direction adapting to the non-ideal characteristics.

An intermediate feature map obtained during the learning process of the backbone network is input to the digital attention block, the digital attention block performs classification based on the intermediate feature map, the gradients generated from the digital attention block are transferred to the corresponding connection point of the backbone network to serve as a guide for the learning of the backbone network, and the gradient guides the backbone network to adapt to the physical constraints of the analog memory device during the self-distillation process.

In addition, the embodiment further includes deactivating the digital attention block among the backbone network and the digital attention block and performing inference using only the backbone network.

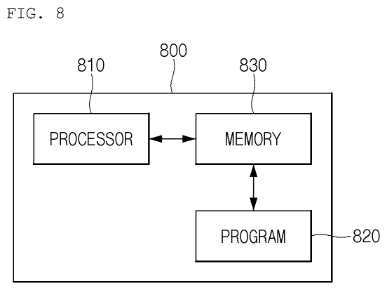

In an embodiment, the configuration of the self-adaptive network is illustrated in FIG. 7, and the operation process thereof will be described as follows.

The self-adaptive network (SAnet) illustrated in FIG. 7 has a hybrid structure that combines analog and digital components, enabling efficient learning in the AIMC systems. This network consists of four main components.

### 1. Digital Input Convolution Block 100

The digital input convolution block 100 is responsible for a first processing stage of a network. In an embodiment, this block performs a 3×3 convolution operation and preserves a spatial dimension (32×32) of a CIFAR-10 image using a stride of 1 and padding of 1. This block extracts an initial feature of an input image.

### 2. Analog Residual Block 200

The analog residual blocks 200 are central components of the network and perform matrix-vector multiplication computations using an analog memory device. These blocks, which are the main components of the backbone network, have the following characteristics.

The analog residual blocks 200 are composed of BasicBlock or Bottleneck blocks according to an Resnet architecture, and Resnet-10, Resnet-18, and Resnet-34 use BasicBlock including two 3×3 convolutions.

Resnet-50 uses a Bottleneck block composed of a 1×1 convolution, a 3×3 convolution, and another 1×1 convolution.

In an embodiment, a base channel starts at 128 and expands to 128, 256, 512, and 1024 channels in subsequent layers.

The analog residual blocks serve as feature extractors and capture more abstract features as a network depth increases.

### 3. Digital Classifier Module 300

The digital classifier module 300 is a final output layer of the backbone network. This module receives features extracted from the analog residual block 200 and generates the final classification result. For Resnet-10, Resnet-18, and Resnet-34, 512 input features are received and converted into 10 output features (CIFAR-10 classes), and for Resnet-50, 2048 input features are received and converted into 10 output features.

### 4. Digital Attention Blocks 400

The digital attention blocks 400 correspond to the features of the present disclosure and are inspired by the self-distillation architecture. These blocks are positioned at different depths of the backbone network and composed of an attention module and a shallow classifier module.

The attention module performs a separable convolution (SepConv) on the intermediate feature map of the backbone network, the module adopts a 3×3 kernel configuration, consisting of a first convolution with stride 2 and a second convolution with stride 1 and padding 1, and each block performs a depthwise convolution followed by a pointwise convolution, with batch normalization and ReLU activation functions applied after each convolution.

The shallow classifier receives the output of the attention module and generates a separate classification result.

In FIG. 7, solid arrows represent a forward computation path: input image→digital input convolution block→analog residual blocks→digital classifier→final output.

In addition, hallow arrows represent a distillation path: intermediate output of an analog residual block→digital attention block→attention output.

In an embodiment, the digital attention block 400 includes a first attention block connected to an initial part of the network, a second attention block connected to a middle part of the network, and a third attention block connected to a latter part of the network.

In an embodiment, the backbone network and all digital attention blocks are activated during the learning process, and losses are computed for the output of the backbone network and the output of each digital attention block. In addition, during the backpropagation process, the gradients of the digital attention blocks are propagated to the backbone network to induce learning.

During the inference stage, the digital attention block is deactivated, and only the backbone network is activated, generating an output from the input image.

In an embodiment, through such a configuration and connection relationship, it is possible to implement the hybrid approach that effectively overcomes the non-ideal characteristics of the AIMC, uses the accurate gradients provided by the digital attention block during the learning process, and maximizes energy-efficient analog computation during the inference process.

Hereinafter, each operation will be described in detail as follows.

### First Operation S10

During the first operation, the backbone network and the digital attention block are simultaneously activated. The backbone network is the main network architecture including analog residual blocks (e.g., ResNet-10, 18, 34, 50). In an embodiment, the digital attention block 400 is composed of three blocks (the first to third digital attention blocks), each of which targets a different feature map of the backbone network. In the present embodiment, it is possible to maximize the effectiveness of the self-distillation architecture by activating the two components simultaneously.

The on-chip learning is performed directly within AIMC hardware, and learning data, such as a CIFAR-10 dataset, may be used as an input image with a size of 32×32×3. In addition, data augmentation techniques (random cropping, horizontal flipping) may be applied, thereby enhancing the learning effect. In an embodiment, learning may be performed using a stochastic gradient descent (SGD) optimizer with a batch size of 128, and an initial learning rate is set to 0.01 and momentum is set to 0.9, and the learning rate is reduced to a minimum of 0.0001 using a cosine annealing schedule.

### Second Operation S20

This operation calculates a self-adaptive loss.

A knowledge distillation method of the present disclosure operates differently from conventional methods.

First, conventional knowledge distillation methods use various types of loss functions, such as a cross-entropy loss for a hard ground truth, KL divergence for a soft ground truth, and L2 regularization for a feature map. However, the present disclosure simplifies hardware implementation using only a single cross-entropy loss.

Typical knowledge distillation ensembles the outputs of all blocks to produce the final result, but SALMON uses only logits of the backbone network.

In addition, the digital attention block in the present disclosure compensates for losses due to the non-ideal characteristics of the analog devices as follows.

First, each digital attention block receives the intermediate feature map of the backbone network and performs classification. The gradients generated during this process is propagated back to the backbone network to guide learning. Grad-CAM analysis results confirmed that the clarity of the gradient was improved as more attention blocks were added. This shows that the digital attention block compensates for the gradient information blurred by noise in the analog device.

In an embodiment, the total loss function Lₜₒₜₐₗ is as shown in Equation 1.

$${ℒ}_{total} = {ℒ}_{CE} ( {y}_{0} , \hat{y} ) + {\sum }_{i = 1}^{3} α \cdot {L}_{CE} ( {y}_{i} , \hat{y} ) \qquad [ Equation 1 ]$$

where y₀ denotes an output of the backbone network, and y₁, y₂, and y₃ denote outputs of the three digital attention blocks. [symbol] _{CE}(y₀,ŷ) denotes the cross-entropy loss of the backbone network including the analog component, α· [symbol] _{CE}(yᵢ,ŷ) denotes the cross-entropy loss between prediction yi and a target ground truth y, and α denotes a loss coefficient used to balance the contributions of different outputs.

In this way, the total loss is computed by combining a classification loss for a backbone network output y₀ and classification losses for outputs of the three digital attention blocks.

The total loss Lₜₒₜₐₗ computed in this way is used for backpropagation. A gradient of a loss for a trainable parameter \grave{θ} is computed by differentiating the loss function with respect to a model parameter θ as shown in Equation 2.

$${∇}_{θ} {ℒ}_{total} = {∇}_{θ} ( {ℒ}_{C E} ( {y}_{0} , y ) + {\sum }_{i = 1}^{3} {ℒ}_{C E} ( {y}_{i} , y ) ) \qquad [ Equation 2 ]$$

In this gradient calculation, a first term ∇θL_{CE}(y₀, y) is the gradient of the loss for the output of the backbone network, a second term Σ∇θ(α·L_{CE} (yᵢ, y)) is the gradient of the loss for the outputs of the three digital attention blocks, and the gradients obtained from the digital attention blocks directly contribute to learning for the backbone network. This gradients correct errors due to the non-ideal characteristics of the analog components (such as noise, nonlinearity, limited conductance states, etc.).

### Third Operation S30

In an embodiment, in this operation, the model parameters are updated using SGD using the computed gradient.

In an embodiment, the initial learning rate is set to 0.01, and the momentum is set to 0.9. The learning rate decreases to a minimum of 0.0001 according to a cosine annealing schedule.

Meanwhile, in the present disclosure, during the on-chip learning, the self-distillation process is performed during the activation of the digital attention block, directly transferring knowledge from the ground truth to each digital attention block, and this process will be described in more detail below.

The self-distillation process in the present disclosure takes a unique approach different from conventional knowledge distillation, and traditional knowledge distillation transfers knowledge from a teacher model to a student model, but in the present disclosure, each digital attention block learns knowledge directly from the ground truth (ground truth). This may be determined using Equation 1. According to Equation 1, the output yi of each digital attention block is directly compared to a true ground truth y, and loss is computed.

In addition, in the present disclosure, the backbone network and the digital attention blocks are learned simultaneously, each receiving learning signals directly from the same ground truth. This creates a kind of ensemble learning effect, but only the output of the backbone network is used for the final prediction.

In addition, the digital attention blocks use intermediate feature maps extracted from different layers of the backbone network as input. This architecture learns feature representations at multiple levels, thereby enhancing the robustness of the backbone network as a feature extractor.

Meanwhile, a process of directly transferring knowledge to the digital attention block is performed as follows.

### 1. Feature Extraction During Forward Path

As input data x passes through the backbone network, intermediate feature maps are generated at multiple layers. These intermediate feature maps are transferred to the corresponding digital attention blocks (the first to third digital attention blocks).

### 2. Independent Classification of Attention Blocks

Each digital attention block performs a separable convolution (SepConv) computation on the input feature maps and then generates the class prediction yi through the digital shallow classifier.

### 3. Direct Supervised Learning

The prediction yi of each attention block is directly compared to the true ground truth y, and a cross-entropy loss L_{CE}(yᵢ, y) is computed. During this process, ground truth knowledge is directly transferred to the attention block. This contrasts with traditional knowledge distillation, which indirectly transfers knowledge through soft targets in the teacher model.

### 4. Knowledge Propagation Through Gradients

The gradients of the losses computed by each attention block Ve(a L_{CE}(yᵢ, y)) are also propagated to the backbone network during backpropagation, and since the gradients are digitally computed, the gradients are accurate and unaffected by the non-ideal characteristics of the analog devices. Consequently, the clean gradient signal compensates for noise and non-ideal characteristics occurring in the analog part of the backbone network.

Meanwhile, the embodiment includes two main strategies, that is, the sparse strategy and the warm-up strategy, for efficient usage of the digital attention block. The two strategies provide a method of improving the learning performance of the AIMC while optimizing computational efficiency and energy consumption.

First, the sparse strategy selectively activates the digital attention block at predefined intervals Ts rather than using the digital attention block during all learning operations.

The interval Ts is defined as an interval at which the digital attention block is activated. For example, when Ts=10, the digital attention block is activated only every 10^{th} epoch. Accordingly, when the sparse strategy is activated, the outputs y₁, y₂, and y₃ of the digital attention blocks are computed only when an epoch e is a multiple of Ts, and only in this case, the loss of the digital attention block is included in the loss function. In other epochs, the digital attention block is deactivated, y₁, y₂, and y₃ are not computed, and the loss function becomes simply Lₜₒₜₐₗ=L_{CE}(y₀, y).

This sparse strategy can significantly reduce the computational burden and energy consumption of the DPU.

Experimental results show that the selection of an appropriate Ts value (e.g., Ts=10 or Ts=25) results in minimal performance degradation compared to continuously using the digital attention block. In particular, the sparse strategy incurs less performance loss on devices with less severe non-ideal characteristics.

Next, the warm-up strategy activates the digital attention block only during the initial learning stage and then deactivates the digital attention block.

The warm-up period Tw defines the number of initial epochs during which the digital attention block is activated. For example, when Tw=50, the digital attention block is activated only for the first 50 epochs.

When the warm-up strategy is activated, the outputs y₁, y₂, and y₃ of the digital attention block are computed only when the epoch e is less than Tw, and the loss function includes the loss of the digital attention block only during this period. In epochs after Tw, the digital attention block is deactivated, allowing only the backbone network to continuously learn.

The warm-up strategy helps the backbone network learn a good initial representation during the initial learning stage through the guide of the digital attention block. Then, the backbone network continuously learns independently, thereby increasing computational efficiency.

Experimental results show that the selection of an appropriate Tw value (e.g., Tw=20 or Tw=50) results in minimal performance degradation compared to continuously using the digital attention block throughout the entire learning period. In particular, a strong gradient signal initially provided by the digital attention block helps overcome the initial learning instability due to the non-ideal characteristics of the analog devices.

Another embodiment of the present disclosure relates to a computing device that implements the self-adaptive digital-analog hybrid learning method.

FIG. 8 is a schematic block diagram illustrating the configuration of the computing device, reconstructing the series of components from the perspective of hardware configuration. Accordingly, to avoid overlapping descriptions, only an outline focusing on functions and operations of each component will be briefly described below.

A computing device 800 includes a memory 830 for storing a computer-readable coded program 820 for the self-adaptive digital-analog hybrid learning method, and a processor 810 for executing the program.

Meanwhile, a computer-readable medium according to the embodiment of the present disclosure may include a computer-readable storage medium and store instructions, commands, or programs for executing the method according to the embodiment of the present disclosure on a computer. The computer-readable recording media include all types of recording devices that store data readable by a computer system.

Examples of the computer-readable recording media include a ROM, a RAM, a CD-ROM, a magnetic tape, a floppy disk, optical data storage devices, etc. In addition, the computer-readable recording media may be distributed across a network-connected computer system to allow the computer-readable code to be stored and executed in a distributed manner. In addition, functional programs, codes, and code segments for implementing the present disclosure can be easily inferred by programmers in the art to which the present disclosure pertains.

A computer-readable medium according to the embodiment of the present disclosure stores one or more instructions, and the instructions executable by one or more processors allow the device to perform an operation of performing on-chip learning using learning data while activating both the backbone network and the digital attention block, an operation of computing a loss function based on the output from the backbone network and the outputs from the digital attention block, and an operation of updating the parameters of the backbone network using the loss function. In this case, the gradients from the digital attention block correct errors due to non-ideal hardware characteristics during the learning process of the backbone network.

The present disclosure has been described above with reference to various embodiments thereof. Those skilled in the art to which the present disclosure pertains will understand that the present disclosure may be implemented in a modified form without departing from the essential characteristics of the present disclosure. Accordingly, the disclosed embodiments should be considered in an illustrative rather than a limiting sense. The scope of the present disclosure is described in the claims rather than the above description, and all differences in the equivalent scope should be construed as being included in the present disclosure.

What is claimed is:

1. A self-adaptive digital-analog hybrid learning method for analog in-memory computing (AIMC) based on a backbone network including an analog memory device and a self-adaptive network including a digital attention block, the method comprising:
performing on-chip learning using learning data while activating both the backbone network and the digital attention block;
computing a loss function based on an output of the backbone network and an output of the digital attention block; and
updating parameters of the backbone network using the loss function,
wherein gradients from the digital attention block correct errors due to non-ideal hardware characteristics during the learning process of the backbone network.

2. The method of claim 1, wherein the on-chip learning performs a self-distillation process upon the activation of the digital attention block, thereby directly transferring knowledge from a ground truth to each digital attention block.

3. The method of claim 1, wherein the on-chip learning is performed by activating the digital attention block at predetermined intervals (Ts) according to a sparse strategy.

4. The method of claim 1, wherein the on-chip learning is performed by activating the digital attention block only during an initial learning period (Tw) according to a warm-up strategy and then deactivating the digital attention block.

5. The method of claim 1, wherein the loss function is computed as a weighted sum of a cross-entropy loss for the output of the backbone network and cross-entropy losses for the outputs of each digital attention block, and the loss for the output of the digital attention block is computed directly from the ground truth without a self-distillation process in the backbone network.

6. The method of claim 1, wherein non-ideal characteristics occurring during parameter learning of the backbone network include at least one of conductance update asymmetry of analog memory elements, the limited number of conductance states, or a device-to-device variation, and
the digital attention block guides the backbone network in a direction that adapts to the non-ideal characteristics.

7. The method of claim 1, wherein an intermediate feature map obtained during the learning process of the backbone network is input to the digital attention block, and
the digital attention block performs classification based on the intermediate feature map, the gradients generated from the digital attention block are transferred to a corresponding connection point of the backbone network to serve as a guide for the learning of the backbone network, and the gradient guides the backbone network to adapt to physical constraints of the analog memory device during the self-distillation process.

8. The method of claim 1, further comprising deactivating the digital attention block among the backbone network and the digital attention block and performing inference using only the backbone network.

9. A non-transitory computer-readable medium for storing instructions,
wherein the instructions executable by one or more processors allow the device to perform:
performing on-chip learning using learning data while activating both a backbone network and a digital attention block;
computing a loss function based on an output of the backbone network and an output of the digital attention block; and
updating parameters of the backbone network using the loss function, and
gradients from the digital attention block correct errors due to non-ideal hardware characteristics during the learning process of the backbone network.

10. A computing device comprising:
a memory configured to store a computer-readable coded program to perform a self-adaptive digital-analog hybrid learning method; and
a processor configured to execute the program,
wherein the self-adaptive digital-analog hybrid learning method is implemented in a self-adaptive network including a backbone network including an analog memory device and a digital attention block, including:
performing on-chip learning using learning data while activating both the backbone network and the digital attention block;
computing a loss function based on an output of the backbone network and an output of the digital attention block; and
updating parameters of the backbone network using the loss function, and
gradients from the digital attention block correct errors due to non-ideal hardware characteristics during the learning process of the backbone network.

11. The computing device of claim 10, wherein the on-chip learning performs a self-distillation process during the activation of the digital attention block to directly transfer knowledge from a ground truth to each digital attention block.

12. The computing device of claim 10, wherein the on-chip learning is performed by activating the digital attention block at predetermined intervals (Ts) according to a sparse strategy,

13. The computing device of claim 10, wherein the on-chip learning is performed by activating the digital attention block only during an initial learning period (Tw) according to a warm-up strategy and then deactivating the digital attention block.

14. The computing device of claim 10, wherein the loss function is computed as a weighted sum of a cross-entropy loss for an output of the backbone network and cross-entropy losses for outputs of each digital attention block, and the loss for the output of the digital attention block is computed directly from a ground truth without a self-distillation process in the backbone network.

15. The computing device of claim 10, wherein non-ideal characteristics occurring during parameter learning of the backbone network include at least one of conductance update asymmetry of analog memory elements, the limited number of conductance states, or a device-to-device variation, and
the digital attention block guides the backbone network in a direction that adapts to the non-ideal characteristics.

16. The computing device of claim 10, wherein an intermediate feature map obtained during the learning process of the backbone network is input to the digital attention block, and
the digital attention block performs classification based on the intermediate feature map, the gradients generated from the digital attention block are transferred to a corresponding connection point of the backbone network to serve as a guide for the learning of the backbone network, and the gradient guides the backbone network to adapt to physical constraints of the analog memory device during the self-distillation process.

17. The computing device of claim 10, wherein the self-adaptive digital-analog hybrid learning method
further includes deactivating the digital attention block among the backbone network and the digital attention block and performing inference using only the backbone network.
